(19) United States
(12) Patent Application Publication
(10) Pub. No.: US 2003/0023688 A1
(43) Pub. Date: Jan. 30, 2003

(54) Voice-based message sorting and retrieval method

(76) Inventors: Lawrence A. Denenberg, Brookline, MA (US); Erin M. Panttaja, Somerville, MA (US); Christopher M. Schmandt, Winchester, MA (US)

Correspondence Address: STAAS & HALSEY LLP, 700 11TH STREET, NW, SUITE 500, WASHINGTON, DC, 20001, US

(21) Appl. No.: 09/912,352

(22) Filed: Jul. 26, 2001

(51) Int. Cl. G06F 15/16

(52) U.S. Cl. 709/206; 709/207

(57) ABSTRACT

A voice-based interface method to provide user access to retrieve, sort, and navigate through messages in multiple media according to a plurality of message sorting criteria. A particular message may belong to multiple message lists and therefore can be heard in response to different queries. This method provides a consistent interface for navigating through the messages in each list of messages sorted by each criterion, proper insertion of newly arrived messages, and change of message status once the message has been heard.

### BACKGROUND OF THE INVENTION

1. Field of the Invention

The present invention relates to messaging systems based on voice output. More particularly, the present invention relates to a telephone-based messaging system for retrieving, sorting, and navigating different types of message media, such as voice mail, text, and facsimile messages, all of which are enabled by a consistent user interface across the different types of message media.

2. Description of the Related Art

Prior art voice mail retrieval systems generally only allow for the retrieval of voice mail messages in a pre-determined sequential order, where the pre-determined sequential order is generally the order in which the messages were received. Navigating the messages in such a prior art system is slow, because there is no way to jump to a particular message that the user wants to listen to, such as a message received at a particular time. Instead, the user of the system has to go through every message in-between in order to listen to the desired voice mail message.

Due to the general sequential nature of such prior art voice mail systems, a user of sequential prior art voice mail systems does not know ahead of time who a particular message is from before hearing that particular message. This leads to the problem of a user having to spend a lot of time listening to potentially unwanted messages. The same is even more true for prior art systems providing voice access to text messages, or both voice and text messages (unified messaging) as the volume of such messages is often much larger, for many users.

To address this problem, some prior art voice mail and prior art unified messaging systems allow the user of such a system to prioritize messages according to the sender's identity. This prioritization may be based on the sender's telephone number (caller-ID) or the sender's name, as detected in a text message header line or inferred by speech recognition for a voice message. Some other prior art voice and text messaging systems attempt to analyze the body or contents of the message for key words which identify the message as an important message. These prior art message systems may present the high priority messages to the user first when he telephones in to retrieve messages, but the user does not have the ability to change, during the course of the telephone call, which messages are defined to be high priority. In other words, message navigation is still reduced to “next” and “previous” according to some pre-defined message order.

A few prior art message access systems allow the user to ask for messages from a specific person, or to ask from whom messages were received and then ask to hear the messages from one particular person. Some prior art unified messaging systems allow the user to choose between messages of various media.

Prior art voice message retrieval systems show minimal functionality with respect to messages which arrive in the midst of a retrieval session. These “newly arrived” messages are simply stored, and at the end of the session the user may be given the option of listening to them. If a session lasts a long time, perhaps because there are many messages to be heard, then timely messages will not be heard until possibly many minutes after they arrive, if at all.

Further, as both the number of messages as well as knowledge about their contents or delivery particulars increases, it becomes increasingly difficult for a user who phones in to retrieve messages to know whether there are any desired messages or find a particular message he wises to retrieve. In the absence of a computer screen interface, such as used for reading text messages, it is desirable for the user to be able to ask for messages based on a variety of logical criteria, such as “text messages from Joe which arrived after noon” or “all my urgent voice messages”. But the user also must remember which messages have been heard and which ways he has asked for the messages to be sorted, resulting in a high cognitive load which interferes with also understanding the messages. In addition, as session times increase, there is greater probability that new messages arrive in the midst of a message retrieval session; since these may be the most important messages due to their timeliness, it is desirable to present these to the user as well, during the session.

Therefore there exists a need for a voice-based message retrieval system which can present messages to a user according to a variety of search criteria or message retrieval lists, maintain a consistent user interface across all such lists to minimize the cognitive load of message retrieval navigation, and present messages of multiple media such as voice, text, and facsimile through such a consistent user interface. Such a voice-based message retrieval system should also properly handle new messages which arrive during a message retrieval session.

### SUMMARY OF THE INVENTION

It is an aspect of the present invention to provide a message retrieval system that receives different types of message media (e.g. voice mail, facsimile, text, or any other type of message medium) using an auditory user interface.

It is another aspect of the present invention to provide a message retrieval system that dynamically and correctly accesses different types of message media using the same uniform auditory user interface across the different types of categorized message media.

It is a further aspect of the present invention to provide a message retrieval system that properly categorizes different types of message media according to user-specified sorting criteria.

It is a further aspect of the present invention to present to the user each list of categorized messages as a navigable list.

The above aspects may be attained by a system and method that retrieves a plurality of electronic messages, categorizes the plurality of electronic messages by a plurality of different electronic message types, and utilizes a uniform interface across the plurality of different electronic message types to access the plurality of electronic messages.

The above aspect of message list specification may be attained by a message model which: sorts messages according to multiple possible message lists; maintains a concept of “new” and “read” messages across multiple message lists; maintains marking of new messages specific to a particular session; provides a consistent user interface and interpretation of commands (for example, “next message”) to move to a relative location within the message list; and correctly inserts messages which arrive during a user session into an appropriate message list.

The above aspects may also be attained by a system and method that recognizes speech and/or DTMF input using an auditory user interface, dynamically retrieves different types of stored messages using multiple navigable lists based on the input, and outputs the retrieved messages utilizing synthetic speech and/or recorded speech.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a block diagram of an Information server in a distributed information services system, in which the features of the present invention may be implemented.

FIG. 2 is a Venn diagram illustrating overlapping message lists.

FIG. 3 is a diagram which shows the structure of a message record in the message database.

FIG. 4 is a flow diagram illustrative of message list selection at the initialization of a session according to an embodiment of the present invention.

FIG. 5 is a snapshot of the message database and several navigable lists.

FIG. 6 shows the message database at several points in a session.

FIG. 7 is a flow diagram illustrative of session message processing according to an embodiment of the present invention.

FIG. 8 is a flow diagram illustrative of message processing during session termination according to an embodiment of the present invention.

FIG. 9 shows the message database before and after the user hangs up (after the occurrences in FIG. 5).

FIG. 10 is a flow diagram illustrative of new message insertion point processing according to an embodiment of the present invention.

FIGS. 11 through 13 show the structure for a method of dealing with messages that come in during the course of a session.

### DESCRIPTION OF THE PREFERRED EMBODIMENTS

This invention is directed towards a user accessing electronic messages (voice mail, text messages including email, and fax) though a voice user interface. A voice user interface takes commands from the user by speech through speech recognition or through non-voice commands, such as DTMF keys on a telephone, and responds by speaking to the user through recorded digital speech or text-to-speech synthesis. As contrasted to, for example, reading email on a computer screen, there is nothing to look it, only speech to hear, while using this invention; this makes it difficult to navigate through a large number of messages. With synthetic speech presentation of text messages, the user must sometimes pay close attention to understand the text; this makes it even more difficult to remember, for example, what fraction of the total message have been heard and to make sure that all the important messages are accessed.

Although the preferred embodiment for this invention is for use over the telephone, this is not meant to imply that the telephone is an essential aspect of the current invention. It could equally well be applied, for example, to listening to messages in a car while driving, as long as there existed a means, via microphone and loudspeaker, to transfer voice to and from a message storing or accessing computer, which provides the user interface to a computer in the car which stores messages and converts them to speech. Similarly this invention could be used as a means of presenting messages to a blind user at a desktop computer. Since the preferred embodiment is designed for use over the telephone, however, as much of the functionality afforded by voice input as possible should also be afforded by the touch-tone (DTMF) keys on a telephone keypad.

As used herein, “message” includes recorded or synthesized voice, text, fax or other data played through an audio output. “Presented”, with respect to messages, means played. “Presenting a message” means beginning to present the message, but not necessarily presenting the entire message. For example, after beginning to present the message, the user might interrupt the presentation, skip the remainder of the message and command the system to present the next message.

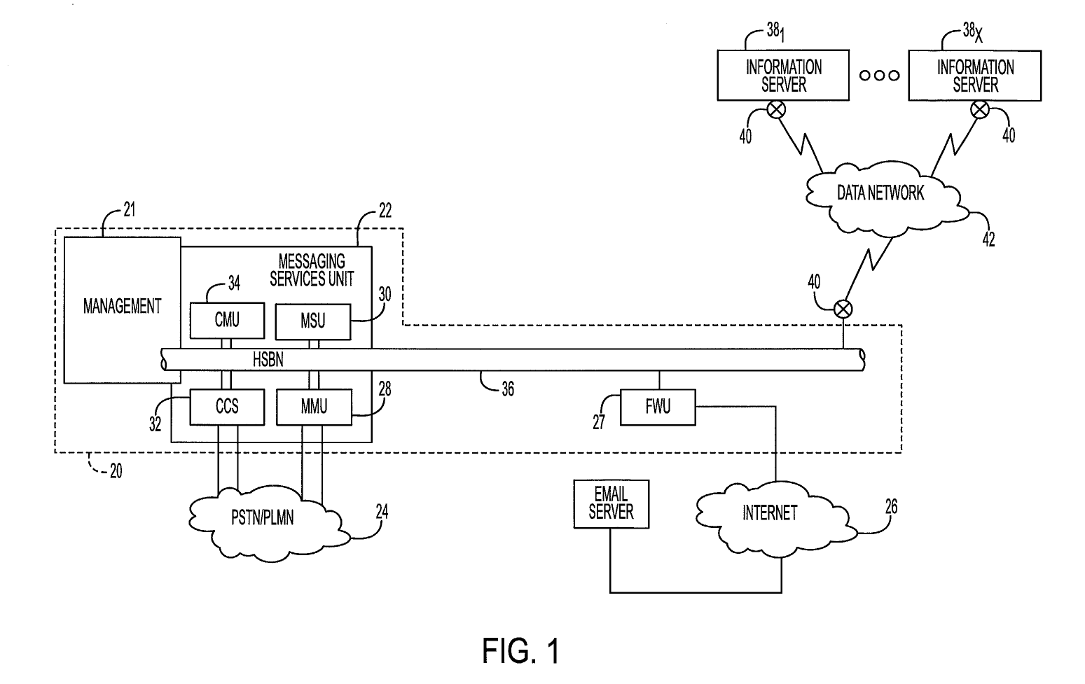

FIG. 1 is a block diagram of an embodiment of information server 20 in which the features of the present invention may be used. In a preferred embodiment, the information server 20 is the TRILOGUE INfinity system from Comverse Network Systems, Inc. of Wakefield, Mass. However, it should be understood that the present invention is not limited to information servers, nor is it limited to information servers having the architecture illustrated in FIG. 1. Specifically, the invention may be employed in any voice controlled apparatus. For example, the features of the present invention may also be applied to the Access NP system which is manufactured and sold by Comverse Network Systems, Inc. of Wakefield, Mass. See U.S. Pat. No. 5,029,199 for a description of such a system.

Referring to the example of FIG. 1, the major components that may be included in the information server 20 include a management unit 21 and a messaging services unit 22 which provides voicemail and facsimile, as well as unified messaging services, such as e-mail and short message services. The short message service messages are conventionally communicated by cellular telephone networks in the PSTN/PLMN 24 or transmitted via a public data communications network such as the Internet 26. The messaging services unit 22 is a voice controlled unit which is composed of a plurality of multi-media units (MMUs) 28 that are connected to voice trunks in the PSTN/PLMIN 24, that perform voice signal processing functions in a plurality of messaging and storage units (MSUS) (and Natural Language Units (NLUs)) 30 that store the subscriber records and host application logic such as the Tel@Go personal assistant application. In addition, the MSUs 30 store various system and custom prompts which are used to activate the various functionality and services provided by the information server 20.

The MMUs 28 can be provided by computers controlled by single or multiple microprocessors, such as Pentium-based computers, manufactured by Comverse Network Systems, Inc. of Wakefield, Mass. with 1 MB memory, 4 GB system disk storage, network interface cards and voice processing cards. The MSU 30 is a similar computer having up to 18 GB additional storage for private subscriber information including personal address books. A call control server (CCS) 32 interfaces with call signaling trunks, such as SS7, system message desk interface (SMDI), etc., in the PSTN/PLMN 24 to provide information on the calling number, etc. The CCS 32 may be a similar Pentium-based computer made by Ulticom Corp. of Mount Laurel, N.J. with network interface cards. Overall control of messaging services is performed by central management unit (CMU) 34 which is connected to the MMUs 28, the MSUs 30 and the CCS 32 by a high-speed backbone network (HSBN) 36, such as a switched Ethernet supporting 10 Base T and 100 base T. The CMU 34 may be an Alpha-based computer made by Compaq of Houston, Tex., with interfaces to the HSBN 36 as well as to a host management computer (not shown) of the network operator.

When a subscriber calls an information server, such as information server 20, the call reaches an MMU 28 which interacts with the subscriber record stored on the subscriber's home MSU 30. The information server 20 is also connected to other information servers 38₁. . . 38ₓ via routers 40 and a data network 42. The CMU 34 performs address resolution to identify the home MSU 30 and communicates with CMUs in other information servers (for example, information servers 38₁ . . . 38ₓ). If the subscriber's call reaches an MMU 28 with his home MSU 30 located on the same information server 20, that is local access. If the home MSU 30 is located on another information server 38₁ . . . 38ₓ, this is considered remote access.

As described above, the messaging and storage units (MSUs) 30 are capable of playing any one of a number of individual audio passages to a user or subscriber in the form of prompts. These prompts are used with respect to a variety of different types of services which are provided by the information server 20. Such prompts invite a user to either enter keystrokes on the telephone or to provide a voice response.

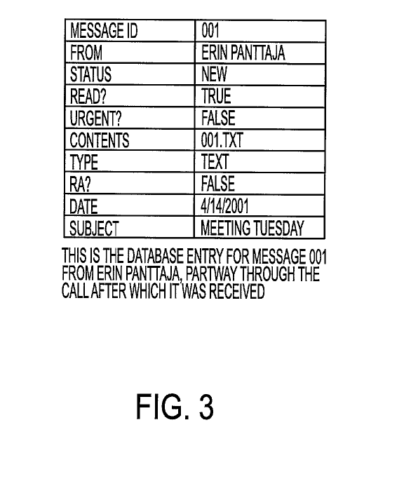

Messages are stored on the MSU 30. The record for each message is in the format illustrated in FIG. 3. Each message has a unique message id to be used in ordering and retrieving the message. The message “from” and “subject” information is preserved, where that information is known. In the case of a fax or voice message, the subject is likely to be left blank, and the “from” field will be present only if the sender can be found in the user's address book.

The status of a message may be either new or old. This information represents whether the message has been read in a previous session. A “session” is a set of interactions with a messaging system. A session extends from a time when it is begun, such as by logging in to a voicemail system or turning on a messaging system in a car, until the set of interactions is terminated by an explicit termination request, such as a logout command, or disconnection from the messaging system, such as by hanging up a telephone or shutting off the messaging system or a larger system, of which the messaging system is a part, such as a car. This field does not change during a session. Read?, on the other hand , changes to true as soon as the user has heard at least the beginning of this message. Urgent?, describes whether or not a message has been marked as urgent. The contents field contains a filename or other pointer to the contents of the message, and the type lists how the message came into the system (text, voicemail, fax, or other message type). The date given indicates the date the message arrived in the mailbox, although this field might contain a time or a time and date.

The present invention provides a telephone-based messaging system which allows dynamic user-selected retrieval of stored messages using multiple navigational lists through the list of all messages. The telephone-based messaging system of the present invention presents messages to a user of the system using an auditory user interface, employing speech recognition and/or DTMF as input, and employing synthetic and/or recorded speech as output. Messages may be categorized as old or new, messages may be categorized as urgent, as being from a particular sender, or according to any user-specified categorization preference. Additionally, the present invention retrieves and categorizes different types of message media, including but not limited to voice, text, and/or fax.

The present invention provides a means of navigating, or moving from message to message, according to user-specified preferences. For example, the present invention allows, but is not limited to allowing, a subscriber or user to hear “all my urgent messages”, “all my e-mail messages”, “my old voice mail messages”, “my fax messages from Erin on Wednesday” and/or “all my messages from Erin”. Thus, the present invention provides powerful mechanisms which allow a user to search for desired messages, as opposed to simply following a default message presentation order.

To allow for dynamic message list selection, the present invention sorts messages according to multiple navigational lists;

a message may appear in more than one list, and different lists need not be subsets of each other maintains a concept of “new” and “read” messages across multiple lists;

maintains marking of new messages specific to a particular session;

provides a consistent user interface with respect to status and ordering of messages across multiple message lists; and

correctly inserts messages which arrive during a user session into an appropriate list.

To facilitate the sorting of messages according to multiple lists, the present invention allows for a user to switch at will between several different lists within the master message list, including but not limited to text messages, fax messages, or messages from a particular contact (e.g. a person). An individual message may be present in multiple lists. When a list is requested, the appropriate messages are selected and sorted according to the user's preferences. Such preferences include, but are not limited to, sorting messages by date, sorting messages by reverse date, or sorting messages by urgent messages first.

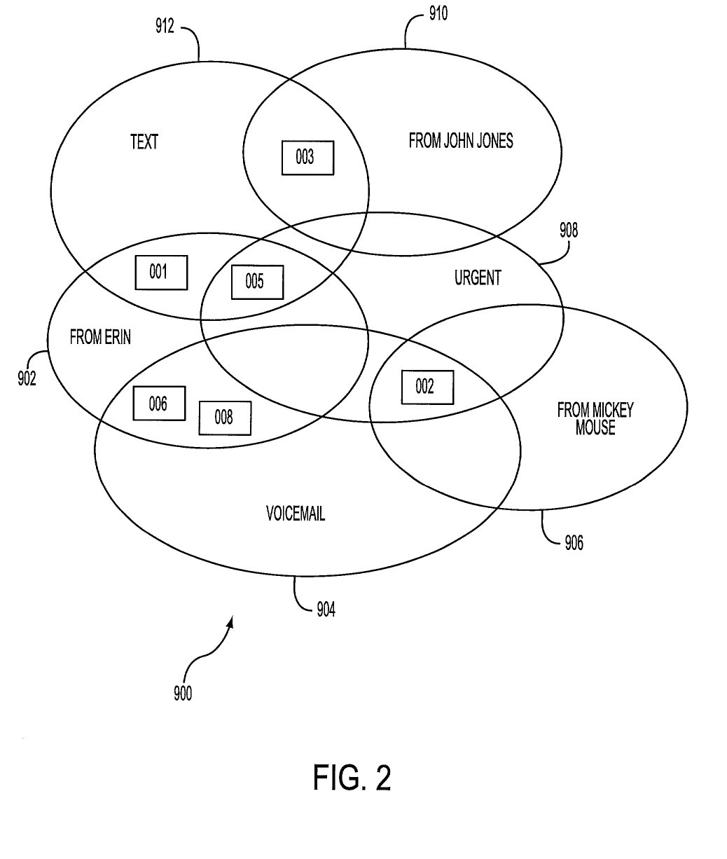

FIG. 2 is a Venn diagram 900 that conceptually illustrates an example of a set of messages 001, 002, . . . 008 stored in a message store, such as in a memory of a voicemail system. The messages 001, 005, 006 and 008 are from Erin, as illustrated by enclosure 902. Similarly, enclosures 904, 906, 908, 910 and 912 identify, respectively, voicemail messages, messages from Mickey Mouse, urgent messages, messages from John Jones and e-mail messages. Each enclosure 902, 904, . . . 912 identifies a set or list (hereinafter collectively “list”) of messages having a common attribute. Some messages, such as messages 006 and 007, are members of more than one list. For example, messages 006 and 007 are in the list of messages from Erin and in the list of voicemail messages, hence these messages are “voicemail messages from Erin”. Similarly, message 005 is an “urgent e-mail message from Erin”.

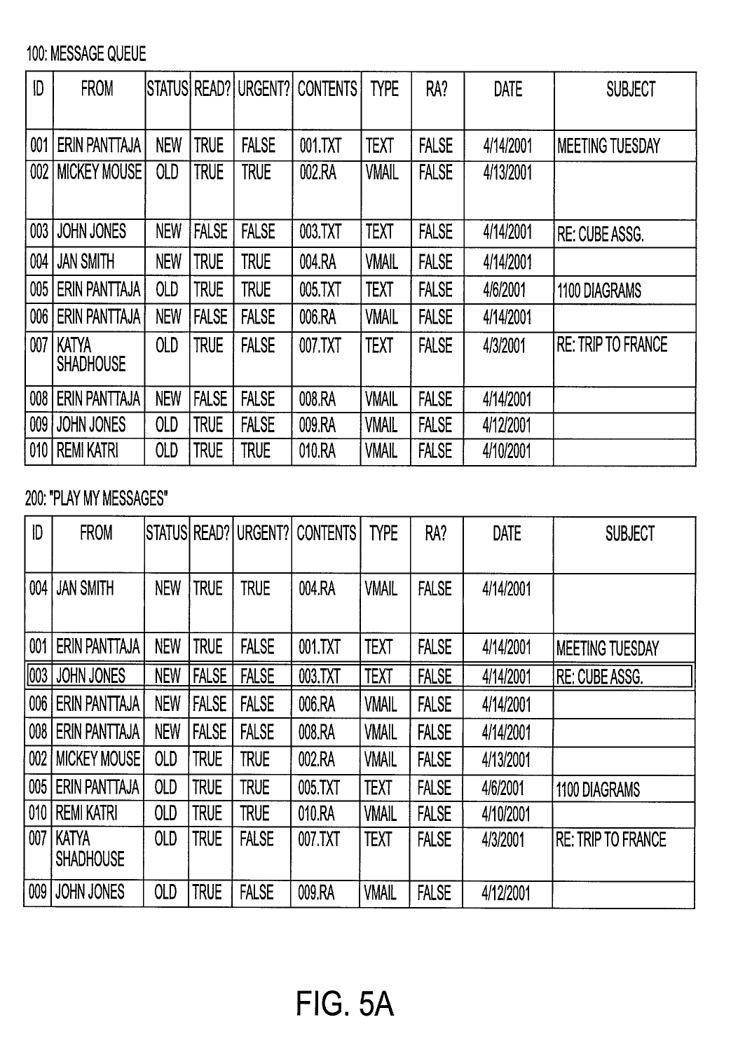

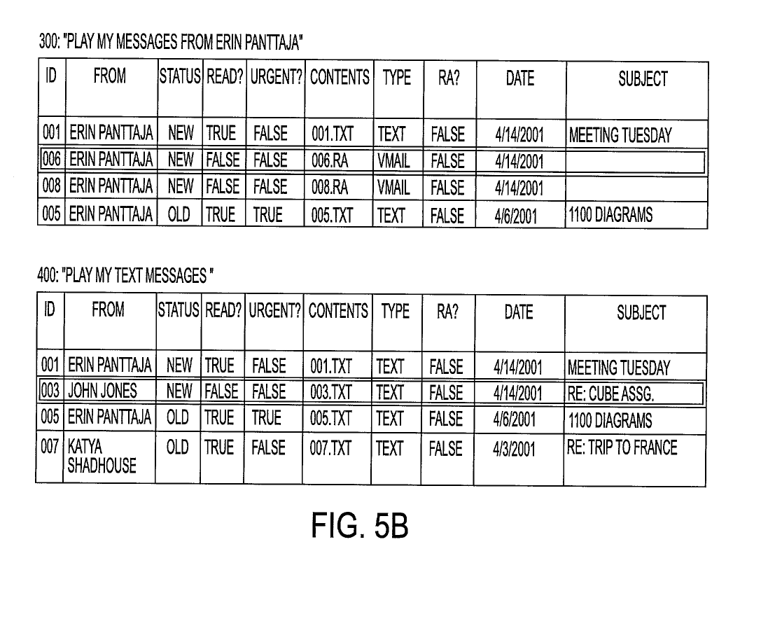

Which list(s) a message is a member of is determined by attributes of the message. FIG. 5, at 100, illustrates an example of several messages 001, 002, . . . , 010 in a message store, as well as some of the attributes associate with each message. Examples of these attributes include a Status, such as “new” or “old”; a Read? flag; an Urgent? flag; a Type, such as “text”, “v-mail” or “fax”; and a received Date. Although no data structure necessarily identifies which list(s) a message is a member of, the list(s) can be ascertained from the message's attributes.

Some of the messages and attributes of FIG. 5 are included in FIG. 2, but, for simplicity, not all the messages and attributes are included therein. For example, received Date is not illustrated in FIG. 2. It can be seen that each message is categorized into one or more lists, and that these lists overlap. For example, the list of messages from Erin 902 overlaps with the list of urgent messages 908. For the purposes of this discussion, we define two “overlapping” lists as having a non-null intersection, where neither list is a subset of the other list. Depending on the attributes of a set of messages stored in a message store at a particular time, some of the possible areas of overlap can be empty. For example, in FIGS. 2 and 5, there are no urgent messages from John Jones. In addition, some pairs of lists always have a null intersection. For example, we would not expect any messages to be both e-mail messages 912 and voicemail messages 904 at the same time. Nevertheless, the remaining messages in these figures are categorized into overlapping lists.

As shown in FIG. 5, whether a message is “new” or “old” (explained further below), is preferably represented by a coded Status attribute, although this distinction could be represented by one or more flags or by other well-known programming techniques. Whether a message has been “read” is preferably represented by a flag, although this information could be stored in an attribute, either alone or in combination with other attributes, or by other well-known programming techniques. Furthermore, whether a message is treated as “new”, “read” or “old” could be represented by a single coded attribute that can take on one of three or more values, such as 0=new, 1=read and 2=old, or by other well-known programming techniques. However the attributes of “new”, “read” and “old”, or their converses, are represented or stored, a message can be considered to have a “tri-state” attribute, which has one of three or more possible values corresponding at least to “new”, “read” and “old”. Some systems might use more than three values and might use more than one value to represent each state here referred to as “new”, “read” or “old”. This tri-state attribute need not be separately stored. Instead, it can be calculated, such as from a list of messages that were played during a session or from a list of frames (explained below) that describe played messages.

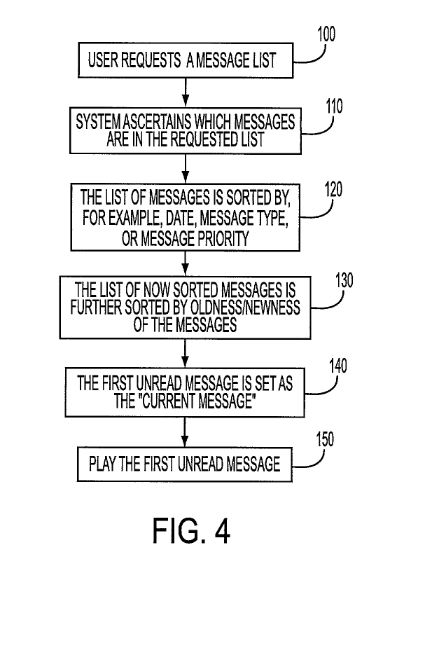

FIG. 4 is a flow diagram illustrative of message list selection according to an embodiment of the present invention. At operation 100, a user requests a message list, such as, for example, “play my text messages.” At operation 110, the system ascertains a list of messages in the requested list. At operation 120, the list of messages is sorted. The list of messages may be sorted based upon user preferences, by, for example, date, message type, or message priority. At operation 130, the list of now sorted messages is further sorted by the newness or oldness of the messages. At operation 140, the first unread message is set as the “current message.” At operation 150, the first unread message is played to the user.

The user may also select a logical composition of criteria in the creation of lists. This includes the use of the words “and” and “or.” Such requests may be of the form “play my text messages from Chris Schmandt,” or “play my messages from Chris Schmandt or Erin Panttaja.”

FIG. 5 shows several different message lists. The first block of messages 100 consists of all of the messages in the database, in no particular order. Block 200 shows what would happen if the user says “play my messages.” The system will play message 003 first. Block 300 shows messages from Erin. Message 006 will be played first. Block 400 shows only email messages; message 003 would be played first.

To maintain a concept of “new” and “read” messages across multiple lists, the present invention keeps the status of a message as new until it is looked at, then the status of the message changes to “read” for the remainder of the session. The “read” status of a message does not change if the user looks at a message while on another list. Later, at the end of the session, all “read” messages are marked “old”, as described below.

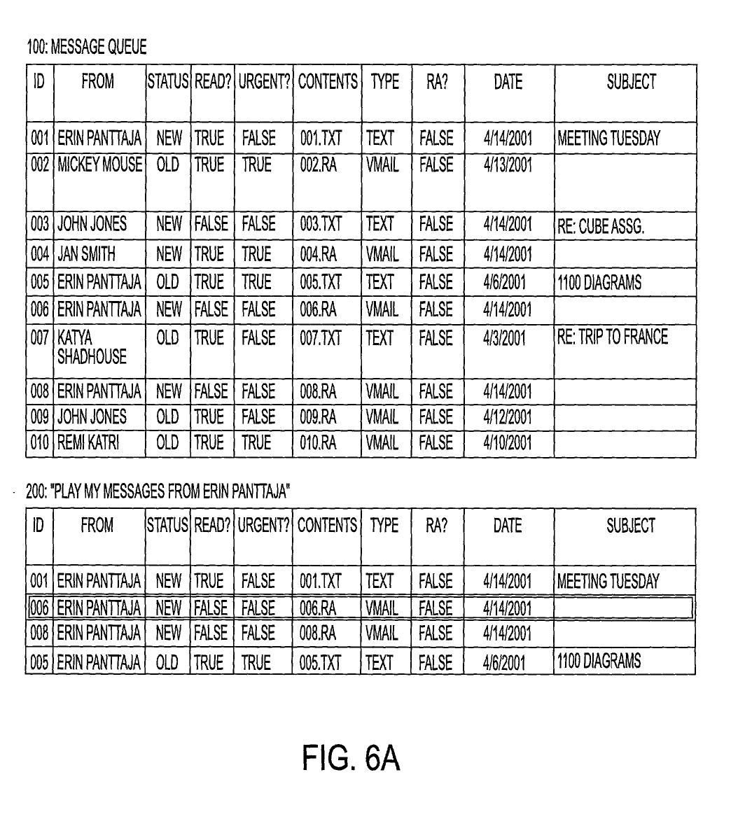

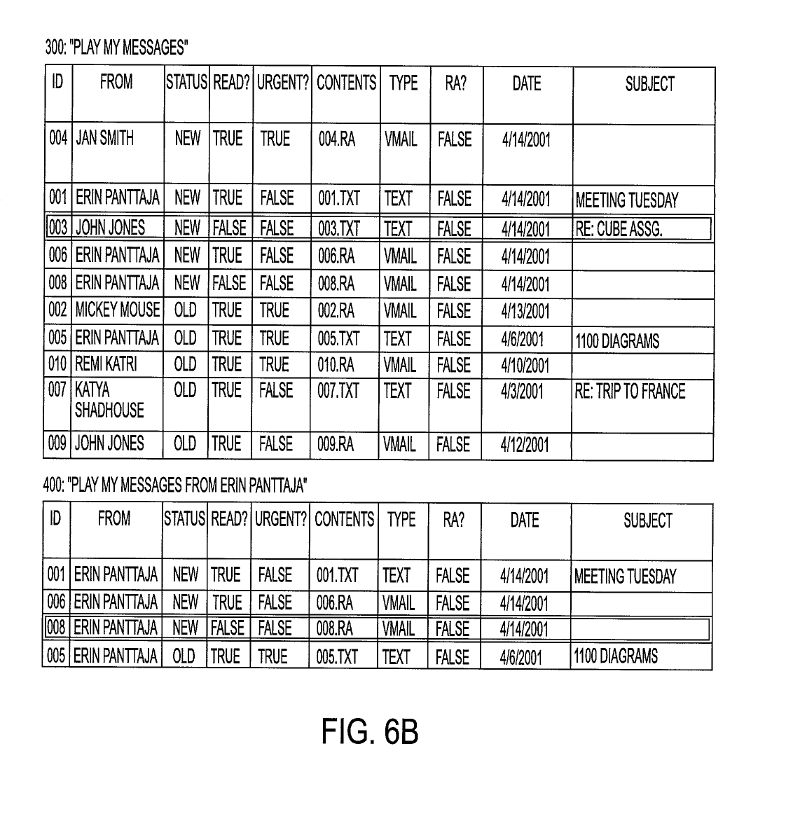

FIG. 6 shows what happens to the message database as a user listens to messages (note that the initial database is the same as that in FIG. 4). Block 100 shows the message database at the beginning of a session. The user says “play my messages from Erin Panttaja” 200. Message 006 is the first message played. After listening to that message, the user says “play my messages” 300, and hears messages 003 from John Jones. The user then says “next” to hear message 006 from Erin Panttaja. Then the user says “play my messages from Erin Panttaja” again, and hears message 008, which is the first unread message, and the next new message from Erin Panttaja.

To facilitate maintaining marking of new messages specific to a particular session according to an embodiment of the present invention, when messages are sorted, messages marked “read” are sorted as “new”, i.e. the messages are treated as though they were marked “new”. This means that, during a given session, the order of the messages will not change. This is particularly convenient in a voice user interface. If a user wants to find a message he or she has heard earlier in the session, it is easy to find despite the difficulty of scanning messages in a traditional voice user interface. In FIG. 6, the orders of messages from Erin, and of all messages, do not change depending on which messages have been heard.

To provide a consistent user interface and a uniform interpretation of commands to move to a relative location along a navigational list, such as “next message”, throughout a session, the ordering of messages within a given list remains constant. This helps the user to find messages previously heard. It is for this reason, in the above description of FIG. 6, that when the user asks for messages from Erin Panttaja, the next unread message, message 008, will be played. If the user says “play my previous message” then message 006 will be played, with the system first announcing that it is a “read” message. This is particularly important in a voice system, in which the user is unable to visually scan the messages for the one they want.

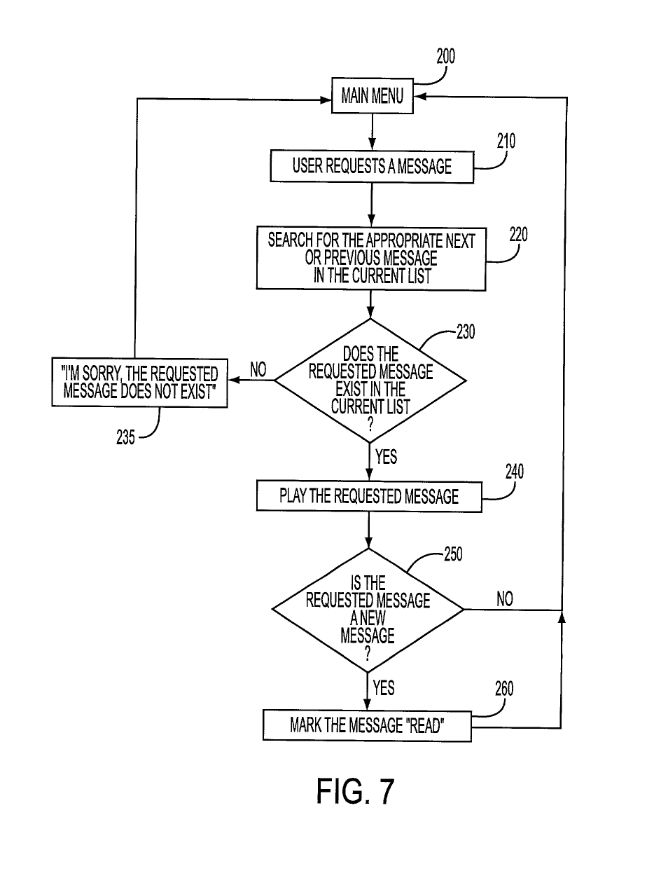

FIG. 7 is a flow diagram illustrative of session message processing according to an embodiment of the present invention. At operation 200, the user is presented with voice-based main menu of options, including but not limited to: request a next message in the current list, request a previous message in the current list, change the current list to a new list, or end the session. At operation 210, the user requests either the next or previous message in the current list. At operation 220, the requested message is searched for in the list. Operation 230 determines whether the requested message exists in the current list. If not, then the system informs the user, either by a pre-recorded audible message or by using voice synthesis, that the requested message does not exist, and processing proceeds back to the main menu at operation 200. If, on the other hand, operation 230 determines that the requested message does exist in the current list, then the requested message is played to the user at operation 240. At operation 250, the system determines whether the requested message is a new message. If not, then processing proceeds to the main menu at operation 200. Otherwise, processing proceeds to operation 260, where the message is marked as “read,” and processing proceeds to the main menu at operation 200. This can be seen in FIG. 6 in messages 006.

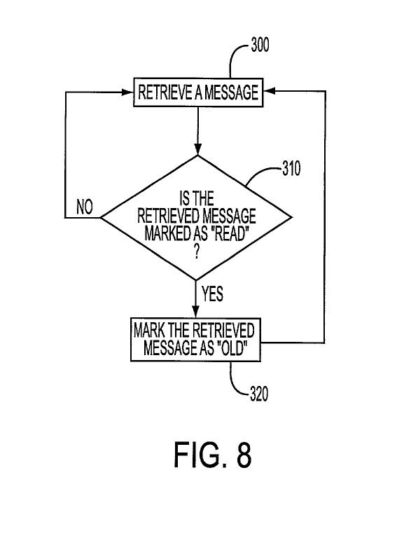

FIG. 8 is a flow diagram illustrative of message processing during session termination according to an embodiment of the present invention. At operation 300, the system retrieves a message. At operation 310, the system determines if the retrieved message has been marked as “read.” If so, then processing proceeds to operation 320, where the read message is marked as “old,” and processing proceeds back to operation 300 until all messages have been retrieved and examined. If, on the other hand, the retrieved message has not been read, then processing proceeds back to operation 300 and the process of the flow diagram of FIG. 5 is repeated until all messages have been retrieved (operation 300), examined (operation 310), and marked as old if already read (operation 320).

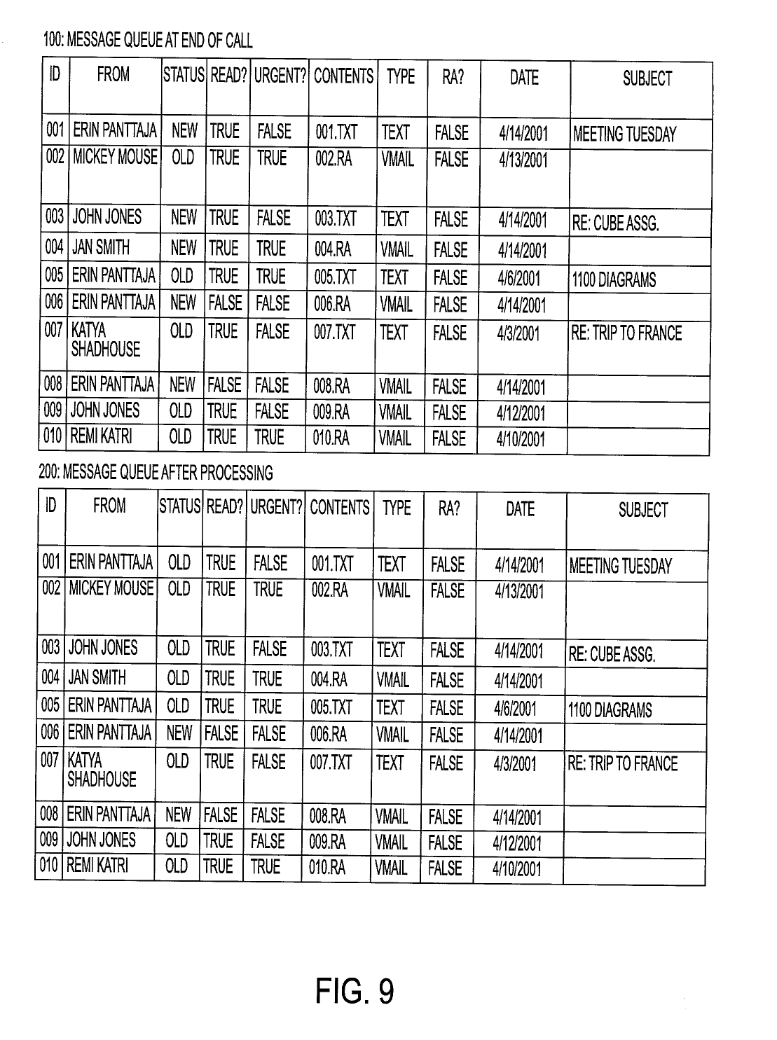

FIG. 9 shows what happens to the database at the end of a session. The first block 100 shows the state of the database after the processing associated with diagram 6. The following block 200 shows the state of the database after those messages marked “read” are marked as “old.” These are messages 001, 003, and 004.

There are several different models for what will be done when a new message arrives during a user session. These may be chosen at the discretion of the service provider.

In one model, when a message is received during a session, it is determined whether it fits in the current list. If it does, and if it would be inserted after the user's current position in the list, the message is inserted in the appropriate place, and labeled as “recently arrived.” Otherwise, the message is inserted as the next message in the current list labeled as “recently arrived,” regardless of list selection criteria. Inserting a message into a message store's data according to attributes of the message is also referred to as “incorporating” the message. For example, the message is incorporated into the current list, if its attributes qualify the message for this list, otherwise the message is incorporated into a different list.

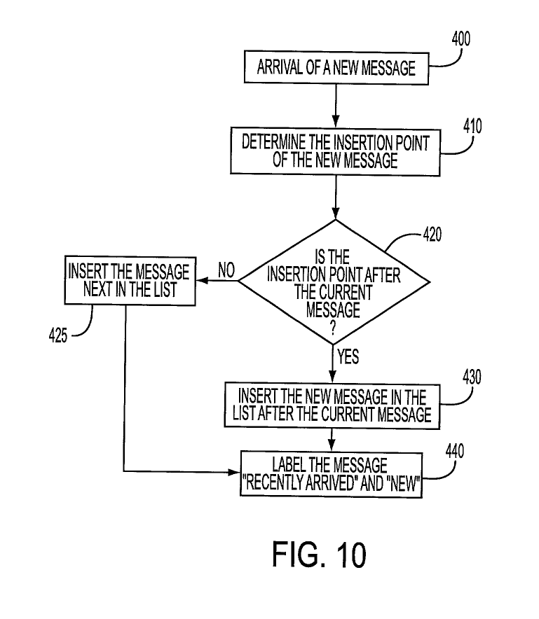

FIG. 10 is a flow diagram illustrative of new message insertion point processing according to an embodiment of the present invention. At operation 400, a new message arrives during a session. At operation 410, the system determines the insertion point of the new message. At operation 420, if the system determines that the insertion point should be after the message currently being played to the user, the new message is inserted into the current list at the appropriate point. At operation 440, the new message is then labeled as “recently arrived” and “new.” If, on the other hand, the new message is determined not to be inserted after the current message, then processing proceeds to operation 425 where the message is inserted next in the list. If there is a subsequent list change, the message will be sorted with the other new messages.

In another model, urgent messages will be played immediately, and all other messages will merely be inserted into appropriate lists at the appropriate position.

In a third model, when a new message arrives in the midst of a user session, the message retrieval system of the present invention decides how to manage it. This system's behavior depends on whether the message would have been heard on any list the user might have taken. If the message would have been heard on any list which the user has chosen in the current session, then the system optionally announces the “newly arrived message”. Otherwise, the system places the new message in whatever place it would otherwise occupy in the list of messages, because the user does not yet know about it.

In order to make this determination, the system determines whether a particular new message would have been heard already. To do so, the system of the present invention keeps track of each navigational list the user has started during a session in a data structure.

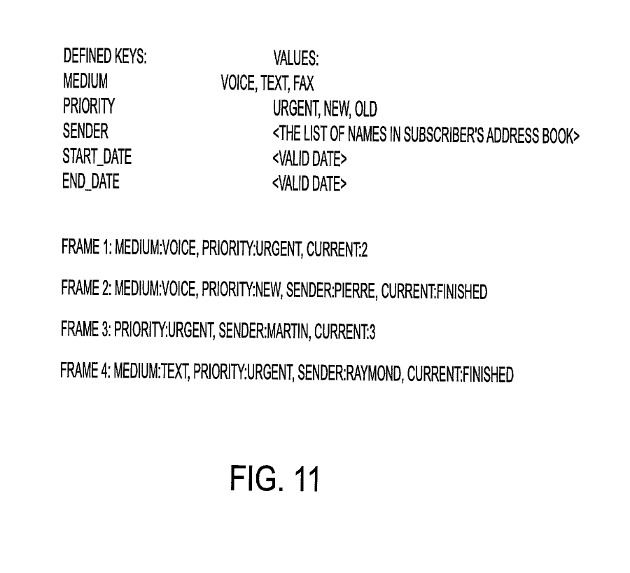

The data structure is a doubly-linked list of “traversal frames”. Each traversal frame contains a series of key:value pairs. These key:value pairs correspond to the optional parameters for specifying a list, such as “my messages”, “my urgent messages”, “my messages from Pierre”, or “my voice messages”. For each possible option type of qualifier to list specification there is a corresponding key. These keys are listed in FIG. 11.

Each frame has one required field, “current”, with a numeric value corresponding to the Nth message in that navigation list which has been presented in the current session, or “finished” indicating that the list has been completed.

When the subscriber asks for a particular message navigation list, such as “Play my urgent email messages”, the system determines whether this is a new navigation list or one the subscriber has already chosen.

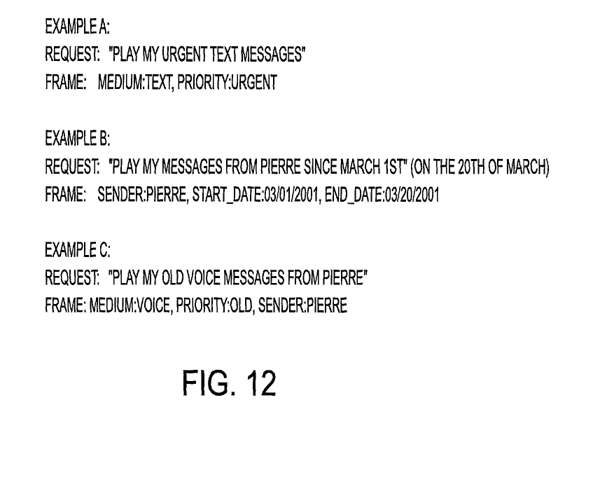

The system first builds a traversal frame from the specified utterance, by examining its parsed form, e.g. after speech recognition. There does not need to be a “current” field specified in the request. This is illustrated by the examples in FIG. 12.

Each time the user starts traversing a new list, the system adds a frame to the database. To find whether a list is new, the system follows the linked list of previously traversed list, looking for an exact match on each field specified by the request. If a field is defined in the request but not in the examined frame (other than the “current” field), or vice versa, there is no match (note that the request frame contains no “current” field).

For example, if the database of previously traversed lists is structured as listed in the frames of FIG. 11, then for the examples in FIG. 12, Examples A and B would represent new lists, while Example C corresponds to Frame 2.

If a match is found, the system determines that the list has been traversed before, and the “current” field depicts how much of it has been heard by the subscriber.

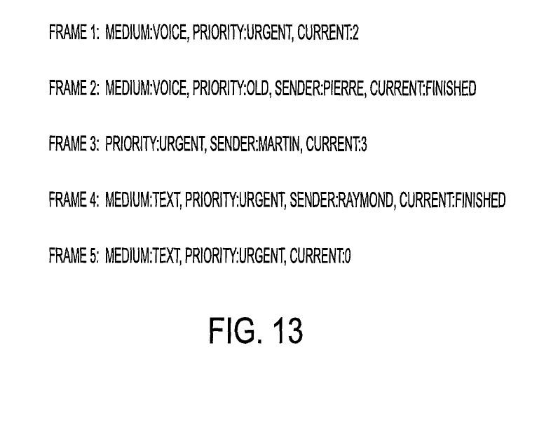

If, on the other hand, a match is not found, then a new frame is created from the frame corresponding to the search, a “current” field is added with value 0, and the new frame is appended to the list of frames. Consequently, after the subscriber requested Example A, “Play my urgent email messages”, the traversed list data structure may be structured as listed in FIG. 13.

When a new message arrives in the middle of a session, the system determines whether the user would have heard it on ANY traversal list he or she has already started. This is accomplished by the following: first, the system defines all the attributes of the message, e.g. a new voice message from Bill would have: medium:voice, sender:Bill, priority:new. Next, for each frame, the system determines if this message matches the frame. A match occurs if each key present in the frame matches against the corresponding key describing the message. The current example does not match any frame:

Frame 1 has priority:urgent and this message is not urgent

Frame 2 has sender:Pierre and this sender is Bill

Frame 3 has sender:Martin and this sender is Bill (and also is not urgent)

Frame 4 and frame 5 specify medium:text and this medium is voice.

Consequently, this message could not have been accessed already and hence can be sorted exactly where it would otherwise go.

As another example, consider a voice message from Martin which is marked as “urgent”. It is described as medium:voice, priority:urgent, sender:Martin. It matches frame 1 AND frame 3, because frame 1 is “any urgent voice message” and frame 3 is “any urgent message from Martin”. If this message would be earlier than the first two “urgent voice messages” (frame 1) or earlier, than the first 3 “urgent messages from Martin” (frame 3), then it must get special treatment and be announced.

A number of terms by which messages may be classified have been presented in this description of the preferred embodiment, such as by sender name, by urgency, or by date received. But this invention is meant to support any of a number of possible terms whereby the entire set of messages may be subdivided or classified into a smaller message list. In particular, we mean to support any field of a user's address book as a means of classifying messages, in addition to names. For example, a user may designate, via a configuration file or graphical user interface possibly presented via the World Wide Web, that the “company name” field be a searchable field. This would allow the user to request “Play my Comverse Technology messages” or “Play my Sun Microsystems messages”; the response to this request would be for the system to find all messages which can be associated, by sender's name or caller-ID, with a person in the user's address book for which the associated “company name” field matches the name spoken by the user.

The is accomplished by the system automatically building a speech recognition grammar which specifies “play my messages from <company name> ” where <company name> would be the list of all values for the “company” field of the address book. Similarly if the address book supported an independent “state” field in the address section the grammar would include “play my messages from <state name>” and the user could request “play my messages from Massachusetts.” This is exactly like the implicit “play my messages from <contact name>” where <contact name> is the list of all people in the user's address book, and was assumed above to allow the user to request messages from a particular sender.

In fact if the user's address book supports an extension mechanism, the current invention allows the user to specify arbitrary user-defined fields upon which to base queries. For example, the user may invent a field named “relationship” and for each entry in the address book fill this “relationship” field with entries such as “work”, “club”, “family”, “friends”, or “dancers”. The user also indicates, as just described, that the “relationship” field is meant to be used as a means of classifying messages. Then the system scans the user's address book, finds all the “relationship” fields, determines what are all possible values for those fields, and puts all these terms in the appropriate place in the speech recognition grammar. Thus the user could ask “Play my friends messages” and hear only those messages from those people she has previous designated as “friend”.

The above is accomplished by the system automatically creating a speech recognition grammar specifying “play my messages from <nameable field> <value>” where <nameable field> is the user-specified name of the address book field (“relationship” in the above example) and <value> is the list of all possible contents for that field in the particular user's address book (“work”, “club”, “family”, “friends”, “dancers” in the above example).

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A messaging system, wherein:
each of a plurality of messages is associated with at least two attributes; and
the plurality of messages is categorized according to the at least two attributes into overlapping lists of messages.

2. The messaging system according to claim 1, wherein the at least two attributes comprise an urgency indicator and a message received date.

3. The messaging system according to claim 2, wherein the at least two attributes further comprise a message medium indicator.

4. The messaging system according to claim 3, wherein the at least two attributes further comprise a message sender identity indicator.

5. The messaging system according to claim 1, wherein each of the plurality of messages is associated with a status that can represent one of at least three distinct statuses.

6. The messaging system according to claim 5, wherein the at least three distinct statuses comprise “new”, “old” and “read”.

7. The messaging system according to claim 6, wherein the at least two attributes comprise an urgency indicator and a message received date.

8. The messaging system according to claim 7, wherein the at least two attributes further comprise a message medium indicator.

9. The messaging system according to claim 8, wherein the at least two attributes further comprise a message sender identity indicator.

10. The messaging system according to claim 1, wherein each of the plurality of messages is associated with a tri-state.

11. The messaging system according to claim 10, wherein the tri-state can represent one of at least three states.

12. The messaging system according to claim 11, wherein the at least three states include “new”, “old” and “read”.

13. A messaging system, comprising:
a memory storing a plurality of messages,
each message being associated with at least two attributes; and
each message being categorized according to the at least two attributes into at least two overlapping lists of messages.

14. The messaging system according to claim 13, wherein the at least two attributes comprise an urgency indicator and a message received date.

15. The messaging system according to claim 14, wherein the at least two attributes further comprise a message medium indicator.

16. The messaging system according to claim 15, wherein the at least two attributes further comprise a message sender identity indicator.

17. The messaging system according to claim 13, wherein each of the plurality of messages is associated with a status that can represent one of at least three distinct statuses.

18. The messaging system according to claim 17, wherein the at least three distinct statuses comprise “new”, “old” and “read”.

19. The messaging system according to claim 18, wherein the at least two attributes comprise an urgency indicator and a message received date.

20. The messaging system according to claim 19, wherein the at least two attributes further comprise a message medium indicator.

21. The messaging system according to claim 20, wherein the at least two attributes further comprise a message sender identity indicator.

22. The messaging system according to claim 13, wherein each of the plurality of messages is associated with a tri-state.

23. The messaging system according to claim 22, wherein the tri-state can represent one of at least three states.

24. The messaging system according to claim 23, wherein the at least three states include “new”, “old” and “read”.

25. The messaging system according to claim 1, wherein the system can select a list of messages for presentation comprising an intersection of at least two of the overlapping lists.

26. The messaging system according to claim 25, wherein the system selects the list of messages for presentation in response to a user input.

27. The messaging system according to claim 13, wherein the system can select a list of messages for presentation comprising an intersection of at least two of the overlapping lists.

28. The messaging system according to claim 27, wherein the intersection is a logical AND or logical OR of the at least two of the overlapping lists.

29. The messaging system according to claim 27, wherein the system selects the list of messages for presentation in response to a user input.

30. A method of processing a newly-arrived message, comprising:
receiving the newly-arrived message during a session; and
presenting the newly-arrived message to a user before the user takes action to end the session.

31. The method according to claim 30, wherein the newly-arrived message is presented only if the newly-arrived message is urgent.

32. The method according to claim 30, further comprising:
interrupting presentation of a message to present the newly-arrived message.

33. The method according to claim 32, wherein the interrupting occurs only if the newly-arrived message is urgent.

34. The method according to claim 30, further comprising:
presenting the newly-arrived message before presenting any other message.

35. The method according to claim 34, wherein the newly-arrived message is presented before presenting any other message only if the newly-arrived message is urgent.

36. The method according to claim 30, further comprising:
ascertaining, in accordance with:
a command issued by the user during the session, but prior to the receiving the newly-arrived message, and
attributes of the newly-arrived message,
whether the system would have presented the newly-arrived message earlier in the session if the newly-arrived message had arrived earlier in the session.

37. The method according to claim 36, further comprising:
if the newly-arrived message would have been presented earlier in the session, interrupting presentation of a message to present the newly-arrived message.

38. The method according to claim 36, further comprising:
if the newly-arrived message would have been presented earlier in the session, presenting the newly-arrived message before presenting any other message.

39. The method according to claim 36, further comprising:
if the newly-arrived message would riot have been presented earlier in the session, including the newly-arrived message in a currently-selected set of message to present to the user.

40. The method according to claim 30, wherein the newly-arrived message is presented before the user changes message selection criteria.

41. The method according to claim 30, further comprising:
adding the newly-arrived message to a set of messages that are currently selected for presentation.

42. A method of processing a newly-arrived message, comprising:
responsive to a user command issued during a session, selecting a set of messages to present to the user;
receiving the newly-arrived message during the session, but after the user command; and
before the user selects a different set of messages for presentation, including the newly-arrived message in the set of message to present to the user.

43. The method according to claim 42, wherein the newly-arrived message is included in the set of messages to present to the user only if attributes of the newly-arrived message satisfy all selection criteria associated with the user command.

44. The messaging system according to claim 1, wherein at least one of the at least two attributes corresponds to at least one non-user-defined field in an address book.

45. The messaging system according to claim 1, wherein at least one of the at least two attributes corresponds to at least one user-defined field in an address book.

46. The messaging system according to claim 13, wherein at least one of the at least two attributes corresponds to at least one non-user-defined field in an address book.

47. The messaging system according to claim 13, wherein at least one of the at least two attributes corresponds to at least one user-defined field in an address book.

48. A messaging system, wherein:
each of a plurality of messages is associated with at least two attributes; and
at least one of the at least two attributes corresponds to at least one non-user-defined field in an address book.

49. A method of processing a newly-arrived message that arrives during a session and while a set of messages is selected for presentation to a user, comprising:
ascertaining at least two attributes of the newly-arrived message; and
during the session and while the set of messages is selected for presentation to the user, inserting the newly-arrived message into the set only if the at least two attributes of the newly-arrived message correspond to attributes of the set.

50. The method according to claim 49, further comprising:
notifying the user of the newly-arrived message.

51. The method according to claim 49, further comprising:
presenting the newly-arrived message to the user.

52. A method of processing a plurality of messages, comprising:
associating at least two attributes with each of the plurality of messages; and
categorizing each of the plurality of messages into at least one of at least two overlapping lists of messages.

53. The method according to claim 52, wherein the at least two attributes comprise an urgency indicator and a message received date.

54. The method according to claim 53, wherein the at least two attributes further comprise a message medium indicator.

55. The method according to claim 54, wherein the at least two attributes further comprise a message sender identity indicator.

56. The method according to claim 52, wherein each of the plurality of messages is associated with a status that can represent one of at least three distinct statuses.

57. The method according to claim 56, wherein the at least three distinct statuses comprise “new”, “old” and “read”.

58. The method according to claim 57, wherein the at least two attributes comprise an urgency indicator and a message received date.

59. The method according to claim 58, wherein the at least two attributes further comprise a message medium indicator.

60. The method according to claim 59, wherein the at least two attributes further comprise a message sender identity indicator.

61. The method according to claim 52, wherein each of the plurality of messages is associated with a tri-state.

62. The method according to claim 61, wherein the tri-state can represent one of at least three states.

63. The method according to claim 62, wherein the at least three states include “new”, “old” and “read”.
